(19) United States
(12) Patent Application Publication
(10) Pub. No.: US 2019/0289481 A1
(43) Pub. Date: Sep. 19, 2019

(54) NETWORK NODE AND CLIENT DEVICE FOR MEASURING CHANNEL STATE INFORMATION

(71) Applicant: Huawei Technologies Co., Ltd., Shenzhen (CN)

(72) Inventors: Johan Christer QVARFORDT, Kista (SE); James GROSS, Kista (SE); Hadi GHAUCH, Kista (SE); Sahar IMTIAZ, Kista (SE)

(21) Appl. No.: 16/435,191

(22) Filed: Jun. 7, 2019

Related U.S. Application Data
(63) Continuation of application No. PCT/EP2016/081747, filed on Dec. 19, 2016.

(51) Int. Cl. H04W 24/08; H04B 7/06; H04L 12/26

(52) U.S. Cl. CPC H04W 24/08; H04L 43/50; H04B 7/0626

(57) ABSTRACT

A network node and a client device are described. The network node comprises a processor configured to determine a test initiation message, wherein the test initiation message indicates a set of client device identities corresponding to a set of client devices participating in a radio configuration test, a number of test packets in a sequence of test packets, and a transmission direction. The transmission direction is at least one of the group consisting of: a first transmission direction from the network node to the set of client devices and a second transmission direction from the set of client devices to the network node. A transceiver is configured to transmit the test initiation message to the set of client devices, and thereafter the transceiver either transmits or receives the sequence of test packets based on the at least one transmission direction. The transceiver also receives at least one feedback message from each client device.

### CROSS REFERENCE TO RELATED APPLICATIONS

This application is a continuation of International Application No. PCT/EP2016/081747, filed on Dec. 19, 2016, the disclosure of which is hereby incorporated by reference in its entirety.

### TECHNICAL FIELD

The embodiments of the invention relate to a network node and a client device.

### BACKGROUND

Radio resources in wireless networks are allocated based on either static allocation schemes or dynamic allocation schemes. Dynamic resource allocation schemes were introduced in 3G and are widely used in 4G networks. To achieve an efficient resource allocation with a dynamic allocation scheme, up-to-date channel state information is required. The channel state information is collected by the system and needs to be continuously updated as the channel state information is varying over time. In scenarios with high mobility, the channel state will vary fast and thereby put a significant burden on the system in terms of overhead to keep the channel state information up-to-date. Conventional methods to collect channel state information by the system are not designed for scenarios with high mobility where the channel state varies very fast.

The next generation wireless networks will add additional complexity to the collection of channel state information due to a significant densification of antennas. Typically, the channel state needs to be characterized with respect to all antennas in the radio environment from which a significant amount of power is received. An increased number of antennas in a radio environment will therefore increase the overhead in the system and make it difficult to keep the channel state information up-to-date.

Another factor that contributes to the overhead generated by the channel state information collection is the number of client devices for which the channel state information needs to be updated. The more client devices in a radio environment, the more processing that is required by the system.

Consequently, in scenarios with high mobility, a large number of antennas, and/or a large number of client devices, a significant burden is put on the systems in terms of overhead to keep the channel state information up-to-date. Conventional methods for collecting information about the transmission behavior of a radio environment, such as channel state information, will not perform well in these scenarios.

### SUMMARY

An objective of embodiments of the invention is to provide a solution which mitigates or solves the drawbacks and problems of conventional solutions.

Another objective of embodiments of the invention is to provide a solution which efficiently generates test data, from which information about the transmission behavior of a radio environment can be extracted.

An “or” in this description and the corresponding claims is to be understood as a mathematical OR which covers “and” and “or”, and is not to be understand as an XOR (exclusive OR).

The above and further objectives are solved by the subject matter of the independent claims. Further advantageous implementation forms of the embodiments of the invention can be found in the dependent claims.

According to a first aspect of the embodiments of the invention, the above mentioned and other objectives are achieved with a network node for a wireless communication system, the network node comprises: a processor configured to:

determine a test initiation message, wherein the test initiation message indicates a set of client device identities corresponding to a set of client devices participating in a radio configuration test, a number of test packets in a sequence of test packets, and at least one of a first transmission direction from the network node to the set of client devices and a second transmission direction from the set of client devices to the network node; a transceiver configured to:

transmit the test initiation message to the set of client devices; and thereafter

transmit or receive the sequence of test packets based on the at least one transmission direction indicated in the test initiation message;

receive at least one feedback message from each client device in the set of client devices, wherein each feedback message indicates at least one of a successful reception of one or more test packets and a successful transmission of one or more test packets.

The network node according to the first aspect provides a number of advantages over conventional solutions. One such advantage is that it enables the network node to efficiently test different radio links to different client devices under various radio conditions, without requiring the involved client devices to be transmitting and/or receiving application layer related payload information. In addition, it enables the network node to efficiently indicate to a selected set of client devices to participate in testing of downlink and/or uplink radio links through a single message transmitted, e.g. broadcasted, to the set of client devices. Another advantage is that it enables the network node to initiate tests that generates test data that may be used as training data for a Machine-Learning algorithm that can make resource allocation decisions based on client device position. Test data can be generated where measurement samples are missing in the training data, thereby making the Machine-Learning algorithm more accurate. A further advantage is that it allows for longer test periods, during which the client devices might have other higher priority user plane data transmissions, without influencing the test participation.

In a first possible implementation form of a network node according to the first aspect, the processor is further configured to:

determine the test initiation message further indicating a timing information for transmission of the sequence of test packets.

The first implementation form enables a start point and an end point of the test period to be flexibly managed by the network node and allows for an arbitrary sequencing of test packets to be transmitted/received, possibly also within a transmission time interval of a wireless communication system.

In a second possible implementation form of a network node according to the first implementation form of the first aspect or to the first aspect as such, the processor is further configured to:

determine the test initiation message indicating the first transmission direction and further one or more test reception parameters.

The second implementation form allows the network node to initiate a sequence of test packets, which are sent under different clearly defined radio configurations in the first transmission direction.

In a third possible implementation form of a network node according to any of the preceding implementation forms of the first aspect or to the first aspect as such, the processor is further configured to:

determine the test initiation message indicating the second transmission direction and further one or more test transmission parameters.

The third implementation form allows in addition a second transmission direction to be set and subsequently allows the network node to initiate a sequence of test packets to be sent under different clearly defined radio configurations in the second transmission direction.

In a fourth possible implementation form of a network node according to any of the preceding implementation forms of the first aspect or to the first aspect as such, the first transmission direction is indicated in the test initiation message, and the feedback message further indicates an error rate associated with one or more test packets.

The fourth implementation form allows the client device to report the error rate of the received test packets to the network node, in particular with respect to the number of bits that are erroneous per test packet.

In a fifth possible implementation form of a network node according the fourth implementation form of the first aspect, the feedback message further indicates a received signal quality associated with one or more test packets.

The fifth implementation form allows the client device to report the received signal quality of the received test packets to the network node, e.g. the signal-to-interference-and-noise ratio (SINR), or an abstract representation of this.

In a sixth possible implementation form of a network node according to any of the preceding implementation forms of the first aspect or to the first aspect as such, the first transmission direction is indicated in the test initiation message, and the transceiver is further configured to:

transmit the sequence of test packets to the set of client devices, wherein each test packet comprises at least one reference signal;

receive at least one feedback message from each client device in the set of client devices, wherein each feedback message indicates a successful reception of one or more test packets.

The sixth implementation form enables the testing of different links to multiple different client devices in the first transmission direction.

In a seventh possible implementation form of a network node according to any of the preceding implementation forms of the first aspect, the second transmission direction is indicated in the test initiation message, and the transceiver is further configured to:

receive the sequence of test packets from the set of client devices, wherein each test packet comprises at least one reference signal;

receive at least one feedback message from each client device in the set of client devices, wherein each feedback message indicates a successful transmission of one or more test packets.

The seventh implementation form enables the testing of different links to multiple different client devices in the second transmission direction.

According to a second aspect of the embodiments of the invention, the above mentioned and other objectives are achieved with a client device for a wireless communication system, the client device comprises:
a transceiver configured to:

receive a test initiation message from a network node, wherein the test initiation message indicates a set of client device identities corresponding to a set of client devices participating in a test transmission, a number of test packets in a sequence of test packets, and at least one of a first transmission direction from the network node to the set of client devices and a second transmission direction from the set of client devices to the network node;
a processor configured to:

verify the participation of the client device in the test transmission based on the test initiation message;
wherein the transceiver is configured to:

transmit or receive one or more test packets in the sequence of test packets based on the at least one transmission direction indicated in the test initiation message;

transmit at least one feedback message to the network node, wherein the feedback message indicates at least one of a successful reception of one or more test packets and a successful transmission of one or more test packets.

The client device according to the second aspect provides a number of advantages over conventional solutions. One such advantage is that the client device is enabled to assist the network node in the testing of different links to the client device under various radio conditions without requiring the client device to be transmitting and/or receiving application layer related payload information.

In a first possible implementation form of a client device according to the second aspect, the test initiation message further indicates a timing information for transmission of the sequence of test packets, and the transceiver is further configured to:

transmit or receive one or more test packets based on the timing information.
The first implementation form allows the client devices to prepare for the test participation and the scheduling of the test packet transmissions, to ensure simultaneous transmission of test packets from client devices or simultaneous reception of test packets at client devices.

In a second possible implementation form of a client device according to the first implementation form of the second aspect or to the second aspect as such, the test initiation message indicates the first transmission direction and further one or more test reception parameters, and the transceiver is further configured to:

receive one or more test packets based on the one or more test reception parameters.

The second implementation form allows the client device to receive a sequence of test packets in the first transmission direction, where the reception is done using different radio configurations defined by the network node with the test reception parameters.

In a third possible implementation form of a client device according to any of the preceding implementation forms of the second aspect or to the second aspect as such, the test initiation message indicates the second transmission direction and further one or more test transmission parameters, and the transceiver is further configured to:

transmit the one or more test packets based on the one or more test transmission parameters.

The third implementation form allows the client device to transmit a sequence of test packets in the second transmission direction, where the transmission is done using different radio configurations defined by the network node with the test transmission parameters.

In a fourth possible implementation form of a client device according to any of the preceding implementation forms of the second aspect or to the second aspect as such, the first transmission direction is indicated in the test initiation message, and the transceiver is further configured to:

receive one or more test packets from the network node, wherein each test packet comprises at least one reference signal;

transmit at least one feedback message to the network node, wherein the feedback message indicates a successful reception of one or more received test packets.

The fourth implementation form enables the client device to report the success of the reception of a sequence of test packets in the first transmission direction to the network node.

In a fifth possible implementation form of a client device according the fourth implementation form of the second aspect, the processor is further configured to:

compute an error rate associated with one or more received test packets; and wherein the feedback message further indicates the error rate.

The fifth implementation form enables the client device to specifically report the error rate, associated with the sequence of test packets, to the network node.

In a sixth possible implementation form of a client device according to the fourth or fifth implementation form of the second aspect, the processor is further configured to:

compute a received signal quality associated with one or more received test packets; and wherein the feedback message further indicates the received signal quality.

The sixth implementation form enables the client device to specifically report the received signal quality, associated with the sequence of test packets, to the network node.

In a seventh possible implementation form of a client device according to any of the preceding implementation forms of the second aspect or to the second aspect as such, the second transmission direction is indicated in the test initiation message, and the transceiver is further configured to:

transmit one or more test packets to the network node, wherein each test packet comprises at least one reference signal;

transmit at least one feedback message to the network node, wherein the feedback message indicates a successful transmission of one or more transmitted test packets.

The seventh implementation form enables the client device to report the success of the transmission of a sequence of test packets in the second transmission direction to the network node.

According to a third aspect of the embodiments of the invention, the above mentioned and other objectives are achieved with a method for a network node, the method comprises:

determining a test initiation message, wherein the test initiation message indicates a set of client device identities corresponding to a set of client devices participating in a radio configuration test, a number of test packets in a sequence of test packets, and at least one of a first transmission direction from the network node to the set of client devices and a second transmission direction from the set of client devices to the network node;

transmitting the test initiation message to the set of client devices; and thereafter

transmitting or receive the sequence of test packets based on the at least one transmission direction indicated in the test initiation message;

receiving at least one feedback message from each client device in the set of client devices, wherein each feedback message indicates at least one of a successful reception of one or more test packets and a successful transmission of one or more test packets.

In a first possible implementation form of a method according to the third aspect, the method further comprises:

determining the test initiation message further indicating a timing information for transmission of the sequence of test packets.

In a second possible implementation form of a method according to the first implementation form of the third aspect or to the third aspect as such, the method further comprises:

determining the test initiation message indicating the first transmission direction and further one or more test reception parameters.

In a third possible implementation form of a method according to the any of the preceding implementation forms of the third aspect or to the third aspect as such, the method further comprises:

determining the test initiation message indicating the second transmission direction and further one or more test transmission parameters.

In a fourth possible implementation form of a method according to any of the preceding implementation forms of the third aspect or to the third aspect as such, the first transmission direction is indicated in the test initiation message, and the feedback message further indicates an error rate associated with one or more test packets.

In a fifth possible implementation form of a method according the fourth implementation form of the third aspect, the feedback message further indicates a received signal quality associated with one or more test packets.

In a sixth possible implementation form of a method according to any of the preceding implementation forms of the third aspect or to the third aspect as such, the first transmission direction is indicated in the test initiation message, and the method further comprises:

transmitting the sequence of test packets to the set of client devices, wherein each test packet comprises at least one reference signal;

receiving at least one feedback message from each client device in the set of client devices, wherein each feedback message indicates a successful reception of one or more test packets.

In a seventh possible implementation form of a method according to any of the preceding implementation forms of the third aspect, the second transmission direction is indicated in the test initiation message, and the method further comprises:

receiving the sequence of test packets from the set of client devices, wherein each test packet comprises at least one reference signal;

receiving at least one feedback message from each client device in the set of client devices, wherein each feedback message indicates a successful transmission of one or more test packets.

The advantages of any method according to the third aspect are the same as those for the corresponding network node claims according to the first aspect.

According to a fourth aspect of the embodiments of the invention, the above mentioned and other objectives are achieved with a method for a client device, the method comprises:

receiving a test initiation message from a network node, wherein the test initiation message indicates a set of client device identities corresponding to a set of client devices participating in a test transmission, a number of test packets in a sequence of test packets, and at least one of a first transmission direction from the network node to the set of client devices and a second transmission direction from the set of client devices to the network node;

verifying the participation of the client device in the test transmission based on the test initiation message;

transmitting or receive one or more test packets in the sequence of test packets based on the at least one transmission direction indicated in the test initiation message;

transmitting at least one feedback message to the network node, wherein the feedback message indicates at least one of a successful reception of one or more test packets and a successful transmission of one or more test packets.

In a first possible implementation form of a method according to the fourth aspect, the test initiation message further indicates a timing information for transmission of the sequence of test packets, and the method further comprises:

transmitting or receiving one or more test packets based on the timing information.

In a second possible implementation form of a method according to the first implementation form of the fourth aspect or to the fourth aspect as such, the test initiation message indicates the first transmission direction and further one or more test reception parameters, and the method further comprises:

receiving one or more test packets based on the one or more test reception parameters.

In a third possible implementation form of a method according to any of the preceding implementation forms of the fourth aspect or to the fourth aspect as such, the test initiation message indicates the second transmission direction and further one or more test transmission parameters, and the method further comprises:

transmitting the one or more test packets based on the one or more test transmission parameters.

In a fourth possible implementation form of a method according to any of the preceding implementation forms of the fourth aspect or to the fourth aspect as such, the first transmission direction is indicated in the test initiation message, and the method further comprises:

receiving one or more test packets from the network node, wherein each test packet comprises at least one reference signal;

transmitting at least one feedback message to the network node, wherein the feedback message indicates a successful reception of one or more received test packets.

In a fifth possible implementation form of a method according the fourth implementation form of the fourth aspect, the method further comprises:

computing an error rate associated with one or more received test packets; and wherein the feedback message further indicates the error rate.

In a sixth possible implementation form of a method according to the fourth or fifth implementation form of the fourth aspect, the method further comprises:

computing a received signal quality associated with one or more received test packets; and wherein the feedback message further indicates the received signal quality.

In a seventh possible implementation form of a method according to any of the preceding implementation forms of the fourth aspect or to the fourth aspect as such, the second transmission direction is indicated in the test initiation message, and the method further comprises:

transmitting one or more test packets to the network node, wherein each test packet comprises at least one reference signal;

transmitting at least one feedback message to the network node, wherein the feedback message indicates a successful transmission of one or more transmitted test packets.

The advantages of any method according to the fourth aspect are the same as those for the corresponding client device claims according to the second aspect.

The embodiments of the invention also relates to a computer program, characterized in code means, which when run by processing means causes said processing means to execute any method according to the present embodiments of the invention. Further, the embodiments of the invention also relates to a computer program product comprising a computer readable medium and said mentioned computer program, wherein said computer program is included in the computer readable medium, and comprises one or more from the group: ROM (Read-Only Memory), PROM (Programmable ROM), EPROM (Erasable PROM), Flash memory, EEPROM (Electrically EPROM) and hard disk drive.

Further applications and advantages of the present embodiments of the invention will be apparent from the following detailed description.

### BRIEF DESCRIPTION OF THE DRAWINGS

The appended drawings are intended to clarify and explain different embodiments of the present embodiments of the invention, in which:

FIG. 1 shows a network node according to an embodiment of the invention.

FIG. 2 shows a method for a network node according to an embodiment of the invention.

FIG. 3 shows a client device according to an embodiment of the invention.

FIG. 4 shows a method for a client device according to an embodiment of the invention.

FIG. 5 shows a wireless communication system according to an embodiment of the invention.

FIGS. 6a-6c show frame structures of an initiation message (IM) and feedback messages (FMs).

FIG. 7 shows a message sequence chart for a single-client device downlink test mode.

FIG. 8 shows a message sequence chart for a multi-client device downlink test mode.

FIG. 9 shows a message sequence chart for a single-client device uplink test mode.

FIG. 10 shows a message sequence chart for a multi-client device uplink test mode.

### DETAILED DESCRIPTION

Conventional solutions to collect channel state information for dynamic resource allocation schemes have major drawbacks in scenarios with high mobility, a large number of antennas, and/or a large number of client devices. In these scenarios, a significant burden is put on the systems in terms of overhead to keep the channel state information up-to-date.

Embodiments of the invention are based on the principle that a given radio environment have statistical properties, which e.g. can be exploited for resource allocation decisions. These statistical properties, which are specific to the given radio environment, the position of the involved antennas, and the positions of the client devices can be learned by the system by collecting a representative base of data regarding the transmission behavior of the radio environment. Resource allocation decisions can then be based on the learned data structure. A prerequisite of such a learning-based approach is that the representative base of data can be collected in an efficient manner from all types of environment, including radio environments with low or infrequent traffic.

Embodiments of the invention introduce a new set of radio configuration tests. This set of radio configuration tests provides efficient schemes for generating test data, from which information about the transmission behavior of a radio environment can be extracted. The radio configuration tests actively generate test data in a radio environment by triggering test packets to be transmitted to and/or from client devices in the radio environment. Information about the transmission behavior, such as e.g. channel state information, can then be extracted from the test data obtained in the radio configuration tests. Allowing information about the transmission behavior to be collected also in radio environments with low or infrequent traffic, i.e. independent on the existence of application layer related payload information. The collected information can e.g. be used as training data for learning-based resource allocation solutions.

According to an embodiment of the invention the radio configuration tests are performed by a network node, such as the network node 100 shown in FIG. 1. The network node 100 comprises a processor 102 coupled to a transceiver 104. The processor 102 and the transceiver 104 are coupled to each other by means of communication 106 known in the art. The network node 100 further comprises an antenna 108 coupled to the transceiver 104, which means that the network node 100 is configured for wireless communications in a wireless communication system.

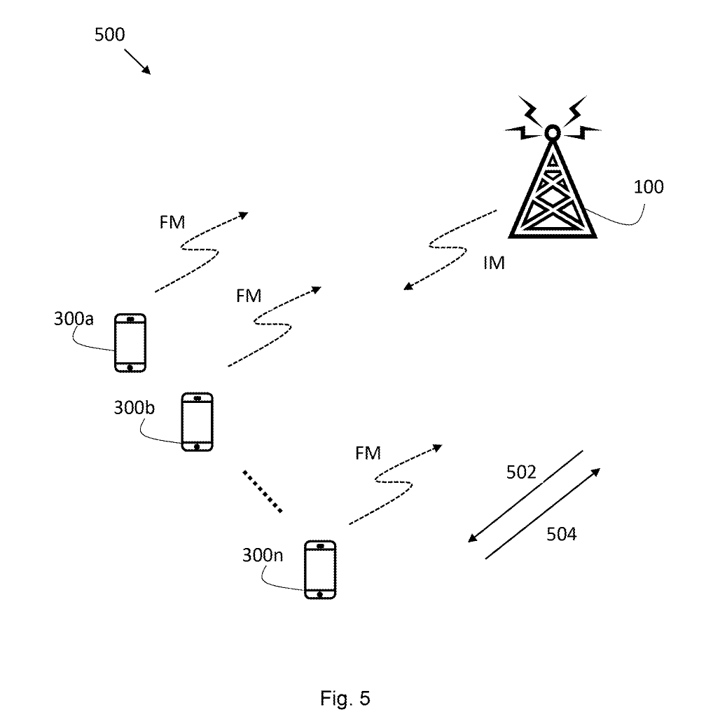

The network node 100 is configured to determine a test initiation message IM. The test initiation message IM indicates a set of client device identities corresponding to a set of client devices 300a, 300b, . . . , 300n (see FIG. 5) participating in a test transmission. A test transmission can involve a single client device 300a; 300b; . . . ; 300n or multiple client devices 300a, 300b, . . . , 300n. Hence, the set of client device 300a, 300b, . . . , 300n can comprise one or more client devices 300a, 300b, . . . , 300n. The test initiation message IM further indicates a number of test packets in a sequence of test packets, and at least one of a first transmission direction 502 (see FIG. 5) from the network node 100 to the set of client devices 300a, 300b, . . . , 300n and a second transmission direction 504 (see FIG. 5) from the set of client devices 300a, 300b, . . . , 300n to the network node 100. The network node 100 is further configured to transmit the test initiation message IM to the set of client devices 300a, 300b, . . . , 300n and transmit or receive the sequence of test packets based on the at least one transmission direction 502; 504 indicated in the test initiation message IM. In one embodiment, the network node 100 transmits the test initiation message IM and/or the test packets using broadcast mode. However, alternative transmission means can also be used e.g. multicast mode or unicast mode. The network node 100 is further configured to receive at least one feedback message FM from each client device in the set of client devices 300a, 300b, . . . , 300n. Each feedback message FM indicates at least one of a successful reception of one or more test packets and a successful transmission of one or more test packets.

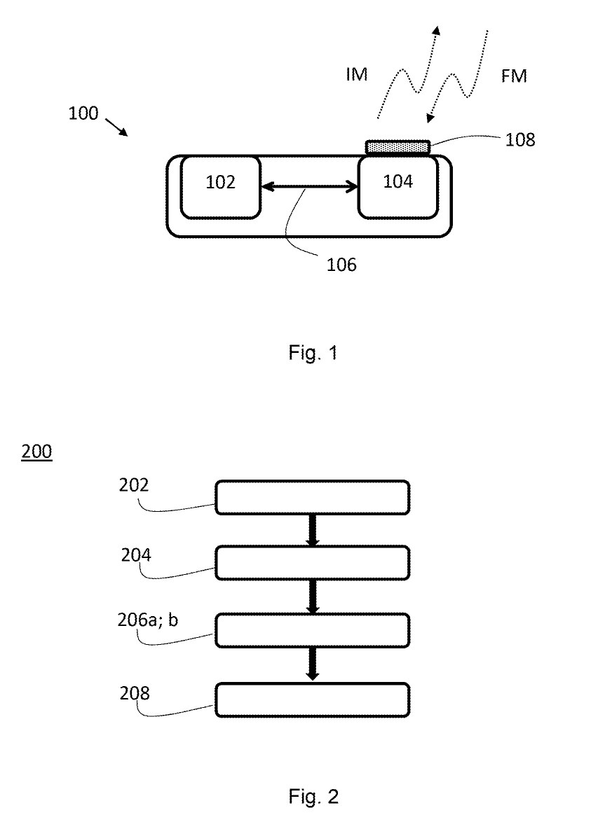

FIG. 2 shows a flow chart of a corresponding method 200 which may be executed in a network node 100, such as the one shown in FIG. 1. The method 200 comprises determining 202 a test initiation message IM. The test initiation message IM indicates a set of client device identities corresponding to a set of client devices 300a, 300b, . . . , 300n participating in a test transmission, a number of test packets in a sequence of test packets, and at least one of a first transmission direction 502 from the network node 100 to the set of client devices 300a, 300b, . . . , 300n and a second transmission direction 504 from the set of client devices 300a, 300b, . . . , 300n to the network node 100. The method 200 further comprises transmitting 204 the test initiation message IM to the set of client devices 300a, 300b, . . . , 300n and transmitting 206a or receiving 206b the sequence of test packets based on the at least one transmission direction 502; 504 indicated in the test initiation message IM. The method 200 further comprises receiving 208 at least one feedback message FM from each client device in the set of client devices 300a, 300b, . . . , 300n. Each feedback message FM indicates at least one of a successful reception of one or more test packets and a successful transmission of one or more test packets.

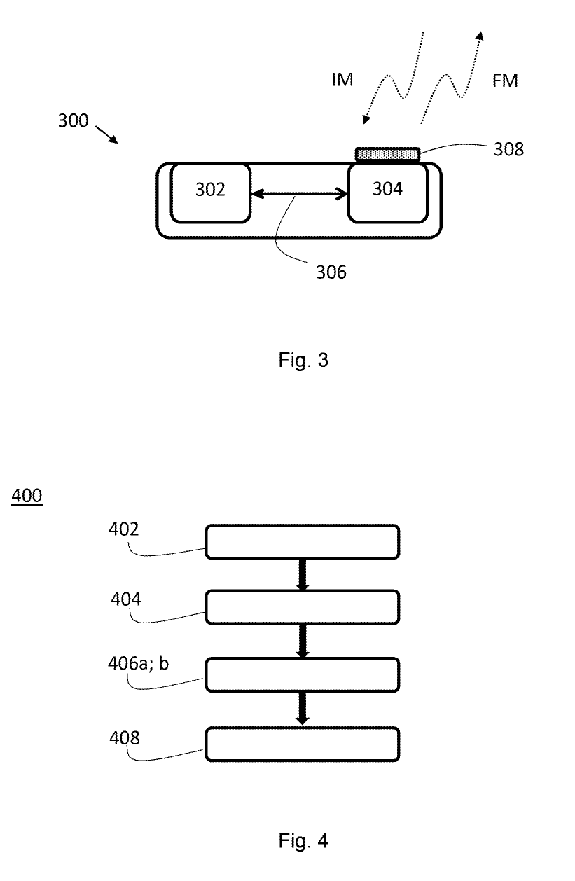

According to an embodiment of the invention, the radio configuration tests are performed by a client device, such as the client device 300 shown in FIG. 3. The client device 300 comprises a processor 302 coupled to a transceiver 304. The processor 302 and the transceiver 304 are coupled to each other by means of communication 306 known in the art. The client device 300 further comprises an antenna 308 coupled to the transceiver 304, which means that the client device 300 is configured for wireless communications in a wireless communication system.

The client device 300 is configured to receive a test initiation message IM from a network node 100. The test initiation message IM indicates a set of client device identities corresponding to a set of client devices 300a, 300b, . . . , 300n participating in a test transmission, a number of test packets in a sequence of test packets, and at least one of a first transmission direction 502 from the network node 100 to the set of client devices 300a, 300b, . . . , 300n and a second transmission direction 504 from the set of client devices 300a, 300b, . . . , 300n to the network node 100. The client device 300 is further configured to verify the participation of the client device 100 in the test transmission based on the test initiation message IM and transmit or receive one or more test packets in the sequence of test packets based on the at least one transmission direction 502; 504 indicated in the test initiation message IM. The client device 300 is further configured to transmit at least one feedback message FM to the network node 100. The feedback message FM indicates at least one of a successful reception of one or more test packets and a successful transmission of one or more test packets.

FIG. 4 shows a flow chart of a corresponding method 400 which may be executed in a client device 300, such as the one shown in FIG. 3. The method 400 comprises receiving 402 a test initiation message IM from a network node 100. The test initiation message IM indicates a set of client device identities corresponding to a set of client devices 300a, 300b, . . . , 300n participating in a test transmission, a number of test packets in a sequence of test packets, and at least one of a first transmission direction 502 from the network node 100 to the set of client devices 300a, 300b, . . . , 300n and a second transmission direction 504 from the set of client devices 300a, 300b, . . . , 300n to the network node 100. The method 400 further comprises verifying 404 the participation of the client device 300 in the test transmission based on the test initiation message IM and transmitting 406a or receiving 406b one or more test packets in the sequence of test packets based on the at least one transmission direction 502; 504 indicated in the test initiation message IM. The method 400 comprises transmitting 408 at least one feedback message FM to the network node 100. The feedback message FM indicates at least one of a successful reception of one or more test packets and a successful transmission of one or more test packets.

FIG. 5 shows a wireless communication system 500 according to an embodiment of the invention. The wireless communication system 500 comprises a network node 100 and a plurality of client devices 300a, 300b, . . . , 300n. Radio configuration tests according to embodiments of the invention can be performed in the wireless communication system 500 to collect information about the transmission behaviour in the radio environment, e.g. channel state information. A radio configuration test is initiated by the network node 100, which transmits a test initiation message IM to the client devices 300a, 300b, . . . , 300n that are selected to participate in the test. The selection of the participating client devices 300a, 300b, . . . , 300n can be performed by the network node 100 and the aim of the selection process is to select client devices 300a, 300b, . . . , 300n that can provide the desired test data. In some scenarios, there is a need to gather test data from a specific area, e.g. an area where no or very little data is available from traffic measurements. In other scenarios the desired test data can be test data from client devices 300a, 300b, . . . , 300n with specific properties, e.g. a specific type of client devices 300a, 300b, . . . , 300n or client devices 300a, 300b, . . . , 300n moving at a certain speed. Hence, the selection process can be based on, but are not limited to, factors, such as location, type, speed, etc. of the client devices 300a, 300b, . . . , 300n. Once a selection is made, the network node 100 transmits the test initiation message IM to the selected client devices 300a, 300b, . . . , 300n. The test initiation message IM includes configuration information to be applied for each test packet. Based on the information in the test initiation message IM, test packets are transmitted between the network node 100 and the selected client devices 300a, 300b, . . . , 300n.

The test packets can be transmitted by the network node 100 to the set of client devices 300a, 300b, . . . , 300n participating in the test, i.e. test packets are transmitted in the first transmission direction 502 shown in FIG. 5. In addition, test packets can be transmitted from the set of client devices 300a, 300b, . . . , 300n participating in the test to the network node, i.e. in the second transmission direction 504 shown in FIG. 5. When all the test packets have been transmitted and received each of the client devices 300a, 300b, . . . , 300n participating in the test transmits a feedback message FM to the network node 100. The feedback message FM includes information such as identifiers for each test packet and indication about the successful treatment of the test packets.

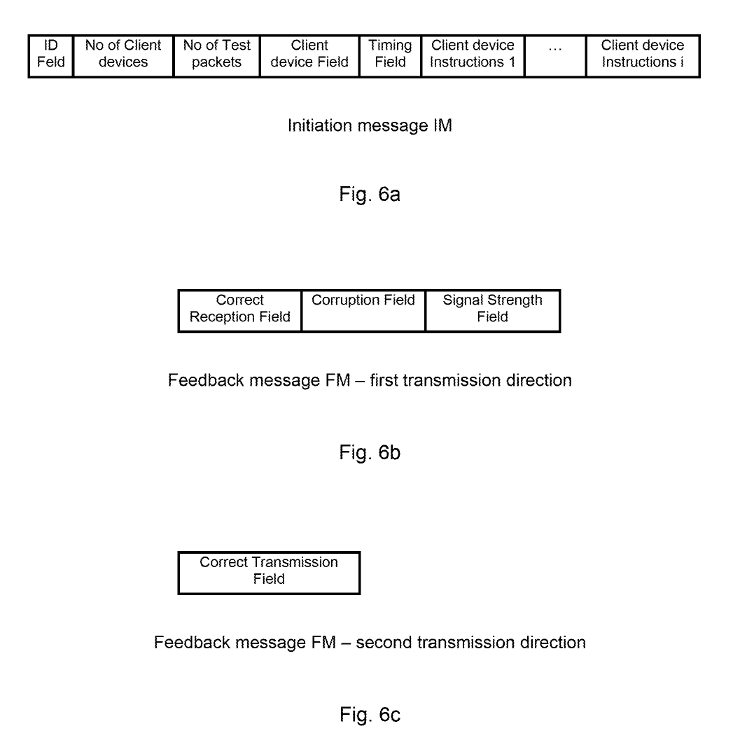

The frame structure of a test initiation message IM according to one embodiment of the invention is shown in FIG. 6a. In this embodiment the test initiation message IM comprises the fields: ID Field, Number of Client devices, Number of Test packets, Client device Field, Timing Field, Client device Instructions 1, . . . , Client device Instructions i (where i is an integer). The fields comprise the following information:
ID Field: Indicates that the following message is an announcement for a test sequence in the first transmission direction 502 and/or the second transmission direction 504.
Number of Client devices: A fixed bitlength field indicating the number of client devices that are involved in the test. This field is used to calculate the beginning of the subsequent fields.
Number of Test packets: Indicates the number of test packets that are going to be transmitted in the test.
Client device Field: A sequence of n ordered client device addresses that are going to be involved in the test procedure. The order is important as it has relevance for the Client device Instruction fields as well as the feedback after the testing.
Timing Field: Indicates the timing information for transmission of the sequence of test packets, including e.g. the time duration (start time-stop time) during which the <Number of Test packets> test packets will be transmitted and the time duration between each test packet.
Client device Instructions: Indicates per client device and per test packet which test reception parameters to use in first transmission direction 502 and/or which test transmission parameters to use in the second transmission direction 504. For the first transmission direction 502 this field contains for example the receive filter and the modulation and coding settings. For the second transmission direction 504 this field contains for example the transmit beam, the modulation and coding settings, as well as the transmit power setting.

The frame structure of a feedback message FM will differ depending on if the test was performed in the first transmission direction 502 or in the second transmission direction 504 or in a combination thereof.

The frame structure of a feedback message FM according to one embodiment of the invention after testing in the first transmission direction 502 is shown in FIG. 6b. In this embodiment, the feedback message FM comprises the fields: Correct Reception Field, Corruption Field, Signal Strength Field. The fields comprise the following information:
Correct Reception Field: Indicates if the one or more test packets were correctly received by the client device.
Corruption Field: Indicates the incorrectly received test packets and how many bit errors were made in the reception process, i.e. the bit error rate associated with one or more test packets.
Signal Strength Field: Indicates a received signal quality associated with one or more test packets, e.g. how strong the SINR was during the reception of each test packets.

The frame structure of a feedback message FM according to one embodiment of the invention after testing in the second transmission direction 504 is shown in FIG. 6c. In this embodiment, the feedback message FM comprises the field: Correct Transmission Field. The field comprises the following information:
Correct Transmission Field: An indication with respect to the test packets if they were correctly transmitted by the client device.

If a combination of the first transmission direction 502 and the second transmission direction 504 is indicated, then the feedback message FM will comprise both the fields described in relation to FIG. 6b and the field described in relation to FIG. 6c.

The radio configuration test can be performed in different modes depending on the number of client devices 300a, 300b, . . . , 300n participating in the test and also depending on whether it is the first transmission direction 502 or the second transmission direction 504 that should be tested. The different test modes and the message exchanged during these test modes will now be described.

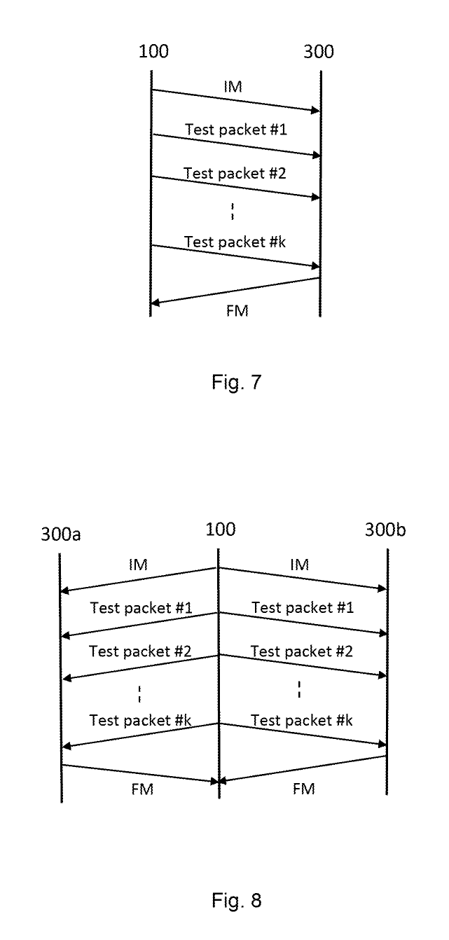

In a single-client device downlink test mode, the radio configuration test is performed between the network node 100 and one client device 300 in the first transmission direction 502. The single-client device downlink test mode is shown in FIG. 7 and comprises the network node 100 transmitting k number of test packets to one client device 300. Each test packet will be used by the network node 100 to extract information about the transmission behavior such as bit error rates, received signal strength, interference parameters, etc. The network node 100 first transmits the test initiation message IM to signal to the client device 300 that the next k test packets are for testing purpose and do not contain any application layer information bits. The test initiation message IM also gives the client device 300 specific information about each test packet. Then, the network node 100 transmits a series of k test packets to the client device 300. Each of the test packets contains predetermined bit-sequences (e.g. a reference signal) that are known to both the network node 100 and the client device 300. The k test packets are received by the client device 300 based on the timing information and the one or more test reception parameters in the test initiation message IM. Finally, the client device 300 transmits a feedback message FM to inform the network node 100 which test packets were successfully received. The feedback message FM can also include information about the bit error rates per test packet, which bits were incorrectly received, which received signal strength was measured for each test packet, as well as interference values for each test packet. This information is computed and included in the feedback message FM by the client device 300. Each of the k test packets can have different settings, different modulation type/order, different coding rates, and/or different receive filter settings for the client device 300. The precise application of these values is indicated by the network node 100 in the test initiation message IM, e.g. in the Client device Instructions field shown in FIG. 6a. This allows the activation and testing of different modes of the downlink channel within one radio configuration test. The different settings can even apply to a subset of symbols of a frame, such that multiple settings can be tested in one frame. The exact timing sequence of the application of the different settings is also contained in the test initiation message IM, e.g. in the Timing Field shown in FIG. 6a.

In the single-client device downlink test mode, the test initiation message IM comprises information about the client device 300 to be scheduled for each of the test packets, as different client devices can be selected for each test packet. As described above the test initiation message IM can also indicate the receiver filter setting to be used by the client device 300 for each test packet, and settings for modulation and coding for each test packet. The feedback message FM serves as feedback to the network node 100 about the n index of test packets that were received correctly by the client device 300, and the index of bits that were incorrectly received. Additional features can include information about received signal strength. This allows the network node 100 to determine the performance of different settings in the radio environment and identify settings which perform better than others.

To increase the efficiency of the proposed radio configuration test a multi-client device downlink test mode is included, whereby the testing is done with multiple client devices 300a, 300b, . . . , 300n in the first transmission direction 502. In the multi-client device downlink test mode, the network node 100 transmits k test packets to each of the client devices 300a, 300b, . . . , 300n participating in the test. Each test packet will be used by the network node 100 to extract information about the transmission behavior such as bit error rates, received signal strength, interference parameters, etc. FIG. 8 shows one embodiment where two client devices 300a, 300b participate in a multi-client device downlink test. The network node 100 first transmits the test initiation message IM to signal to the client devices 300a, 300b that the next k test packets are for testing purpose and do not contain any application layer information bits. Then, the network node 100 transmits a series of k test packets to each client device 300a; 300b. Each of the test packets contains predetermined bit-sequences, e.g. a reference signal, that are known to both the network node 100 and the client devices 300a, 300b. The k test packets are received by the client device 300a, 300b based on the timing information and the one or more test reception parameters in the test initiation message IM. Finally, the client devices 300a, 300b transmit a feedback message FM to inform the network node 100 which test packets were successfully received. The feedback message FM can also include information about the bit error rates per test packet, which bits were incorrectly received, which received signal strength was measured for each test packet, as well as interference values for each test packet. This information is computed and included in the feedback message FM by the client device 300a, 300b. Each of the k test packets can have different settings, different modulation type/order, different coding rates, and/or different receive filter settings for each of the client device 300a; 300b. The precise application of these values is indicated by the network node 100 in the test initiation message IM, e.g. in the Client device Instructions field shown in FIG. 6a. This allows the activation and testing of different modes of the downlink channel within one radio configuration test.

In multi-client device downlink test mode, the test initiation message IM comprises the set of client devices to be scheduled for each test packet, the receive filter setting to be used by each client device 300a; 300b; . . . ; 300n, and the set of modulation and coding parameters for each of the k test packets. In addition, the test initiation message IM also contains the timing information when different modulation/coding settings, as well as different receive filter settings, are to be applied. Finally, in the multi-client device downlink test mode, the test initiation message IM also contains the sequence in which the client devices 300a, 300b, . . . , 300n report their feedback messages FMs. Moreover, the feedback messages FMs can comprise the index of the test packets that were received correctly and the index of bits in the frame that were incorrectly received. The feedback message FM for each client device 300a; 300b; . . . ; 300n might also include additional features such as the receive signal strength for each of the test packets, as well as strength of other interfering transmissions, from other client devices 300a, 300b, . . . , 300n scheduled within the same test.

Note that in the multi-client device downlink test mode, the set of scheduled client devices 300a, 300b, . . . , 300n, the filter setting used by client devices 300a, 300b, . . . , 300n, and the modulation and coding settings may vary across test packets, as well as across client devices 300a, 300b, . . . , 300n.

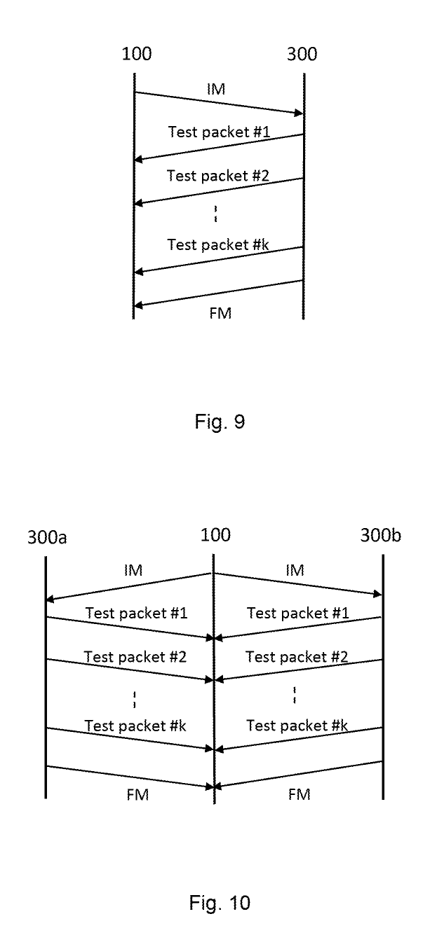

In the single-client device uplink test mode, the second transmission direction 504 is tested by instructing a client device 300 to transmit k test packets to the network node 100. Each test packet will serve as a basis for the network node 100 to extract information about the transmission behavior such as bit error rates, received signal strength, etc. The single-client device uplink test mode is shown in FIG. 9. The network node 100 first transmits the test initiation message IM to signal to the client device 300 that it is supposed to transmit k test packets that do not contain application layer information bits to the network node 100. The client device 300 replies by transmitting k test packets to the network node 100. The transmission is based on the timing information and the one or more test transmission parameters in the test initiation message IM. Each of the test packets contains predetermined bit-sequences (e.g. a reference signal) that are known to both the network node 100 and the client device 300. The test initiation message IM comprises the transmit beam setting to be used by the client device 300, the transmit power to be applied, as well as the modulation and coding settings for each of the k test packets. In addition, the test initiation message IM also contains the timing information when different modulation/coding settings, as well as different transmit beam settings are to be applied.

The content of the feedback message FM in the uplink test mode can be different from the content of the feedback message FM in the downlink test mode. The feedback message FM in the uplink test mode does not have to contain information about index of bits incorrectly received, index of bits correctly received, and received signal strength for each test packet, as this information can be extracted by the network node 100 itself from the received k test packets. Instead, what is needed is a record of the test packets transmitted by the client device 300. Potential data packets can be prioritized over the requested k test packets. Hence, it is not sure that all k test packets will be transmitted and the network node 100 should be informed about which of the k test packets were actually transmitted. The feedback message FM in the uplink test mode therefore allows the client device 300 to indicate which of the k test packets were successfully transmitted. This indication can be implemented with a bitmap or by specifying the index of the test packets that were transmitted or not transmitted.

In the uplink test mode, in analogy to the downlink test mode, a multi-client device setting is defined which increases the efficiency. Here, the test initiation message IM instructs a set of client devices 300a, 300b, . . . , 300n to transmit k test packets with a given timing and given test transmission parameters. FIG. 10 shows one embodiment of a multi-client device uplink test mode, in which two client devices 300a, 300b participate in a multi-client device uplink test. The network node 100 first transmits the test initiation message IM to signal to the client devices 300a, 300b that they are supposed to transmit k test packets that do not contain application layer information bits to the network node 100. Then, each client device 300a; 300b transmits a series of k test packets to the network node 100. The transmission is based on the timing information and the one or more test transmission parameters in the test initiation message IM. Each of the test packets contains predetermined bit-sequences, e.g. a reference signal, that are known to both the network node 100 and the client devices 300a, 300b. Finally, the client devices 300a, 300b transmits a feedback message FM to inform the network node 100 about which test packets were successfully transmitted. Similar to the multi-client device downlink test mode each of the k test packets can have different settings, different modulation type/order, different coding rates, and/or different receive filter settings for each of the client device 300a, 300b. The precise application of these values is indicated by the network node 100 in the test initiation message IM, e.g. in the Client device Instructions field shown in FIG. 6a. This allows the activation and testing of different modes of the uplink channel within one radio configuration test.

The different test modes described above can also be combined such that both the uplink and the downlink is tested for one or more client devices 300a, 300b, . . . , 300n within one radio configuration test. In this combined test mode, the test initiation message IM includes information about the transmission direction 502;504 for each test packet for each client device 300a; 300b; . . . ; 300n participating in the test transmission, in addition to the information described above in relation to the other test modes. Each client device 300a; 300b; . . . ; 300n can thereby be instructed to receive k test packets from the network node 100 and transmit 1 test packets to the network node 100. The number of test packets k; 1 in each transmission direction 502;504 can be the same or different and can be client device 300a; 300b; . . . ; 300n dependent.

The proposed solutions can operate in conjunction with Machine-Learning algorithms, that predict an outcome (transmission success/failure) associated with a given input feature vector. In the training phase of such a Machine-Learning algorithm, a database is populated with instances where the outcome (data transmission success/failure) is known. The performance of the Machine-Learning algorithm is usually related to the presence of bias, in the input data and outcome; this bias corresponds to input/output combinations that are not likely to occur. To avoid this, the network node 100 might schedule test transmissions that have a high chance of failure by scheduling a client device 300a, 300b, . . . , 300n that has low received power, and selecting higher modulation orders than what the channel can support. In contrast, the network node 100 can also schedule a client device 300a, 300b, . . . , 300n with a strong channel and a low modulation order, such that transmission success is highly likely. Moreover, the network node 100 can also schedule transmission with uncertain outcome. For instance, the network node 100 might select client devices 300a, 300b, . . . , 300n with strong channels and high modulation order, client devices 300a, 300b, . . . , 300n with weak channels and low modulation order, or other transmissions where the outcome is uncertain.

The network node 100 herein may also be denoted as a radio network node, an access network node, an access point, or a base station, e.g. a Radio Base Station (RBS), which in some networks may be referred to as transmitter, “eNB”, “eNodeB”, “NodeB” or “B node”, depending on the technology and terminology used. The radio network nodes may be of different classes such as e.g. macro eNodeB, home eNodeB or pico base station, based on transmission power and thereby also cell size. The radio network node can be a Station (STA), which is any device that contains an IEEE 802.11-conformant Media Access Control (MAC) and Physical Layer (PHY) interface to the Wireless Medium (WM). The network node may also be a base station corresponding to the fifth generation (5G) wireless systems.

The client device 300 herein may be denoted as a user device, a User Equipment (UE), a mobile station, an internet of things (IoT) device, a sensor device, a wireless terminal and/or a mobile terminal, is enabled to communicate wirelessly in a wireless communication system, sometimes also referred to as a cellular radio system. The UEs may further be referred to as mobile telephones, cellular telephones, computer tablets or laptops with wireless capability. The UEs in the present context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM). The client device 300 may also be configured for communication in 3GPP related LTE and LTE-Advanced, in WiMAX and its evolution, and in fifth generation wireless technologies, such as New Radio.

Any method according to embodiments of the invention may be implemented in a computer program, having code means, which when run by processing means causes the processing means to execute the steps of the methods. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the network node 100 and the client device 300 comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processor 102 of the network node 100 and the processor 302 of the client device 300 may comprise, e.g. one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g. any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. A network node for a wireless communication system, the network node comprising:
a processor; and
a non-transitory computer-readable medium including computer-executable instructions that, when executed by the processor, facilitate the network node carrying out a method comprising:
determining a test initiation message, wherein the test initiation message indicates:
a set of client device identities corresponding to a set of client devices participating in a radio configuration test,
a number of test packets in a sequence of test packets, and
at least one transmission direction taken from the group consisting of:
a first transmission direction from the network node to the set of client devices, and
a second transmission direction from the set of client devices to the network node;
a transceiver configured to cooperate with the processor to:
transmit the test initiation message to the set of client devices; and thereafter:
transmit or receive the sequence of test packets based on the at least one transmission direction indicated in the test initiation message; and
receive at least one feedback message from each client device in the set of client devices, wherein each feedback message indicates at least one of the group consisting of:
a successful reception of one or more test packets, and
a successful transmission of one or more test packets.

2. The network node according to claim 1, wherein the processor is configured to carry out the method including:
determining the test initiation message further indicates a timing information for transmission of the sequence of test packets.

3. The network node according to claim 1, wherein the processor is configured to carry out the method including:
determining the test initiation message indicates the first transmission direction and further one or more test reception parameters.

4. The network node according to claim 1, wherein the processor is configured to carry out the method including:
determining the test initiation message indicates the second transmission direction and further one or more test transmission parameters.

5. The network node according to claim 1, wherein the first transmission direction is indicated in the test initiation message, and wherein the feedback message further indicates an error rate associated with one or more test packets.

6. The network node according to claim 5, wherein the feedback message further indicates a received signal quality associated with one or more test packets.

7. The network node according to claim 1, wherein the first transmission direction is indicated in the test initiation message, and wherein the transceiver is configured to:
transmit the sequence of test packets to the set of client devices, wherein each test packet comprises at least one reference signal;
receive at least one feedback message from each client device in the set of client devices, wherein each feedback message indicates a successful reception of one or more test packets.

8. The network node according to claim 1, wherein the second transmission direction is indicated in the test initiation message, and wherein the transceiver is configured to cooperate with the processor to:
receive the sequence of test packets from the set of client devices, wherein each test packet comprises at least one reference signal; and
receive at least one feedback message from each client device in the set of client devices, wherein each feedback message indicates a successful transmission of one or more test packets.

9. A client device for a wireless communication system, the client device comprising:
a processor;
a transceiver configured to cooperate with the processor to:
receive a test initiation message from a network node, wherein the test initiation message indicates a set of client device identities corresponding to a set of client devices participating in a test transmission, a number of test packets in a sequence of test packets, and at least one transmission direction taken from the group consisting of:
a first transmission direction from the network node to the set of client devices, and
a second transmission direction from the set of client devices to the network node;
a non-transitory computer-readable medium including computer-executable instructions that, when executed by the processor, facilitate the client device carrying out a method comprising::
verifying the participation of the client device in the test transmission based on the test initiation message;
wherein the transceiver is configured to cooperate with the processor to:
transmit or receive one or more test packets in the sequence of test packets based on the at least one transmission direction indicated in the test initiation message; and
transmit at least one feedback message to the network node, wherein the feedback message indicates at least one of a successful reception of one or more test packets and a successful transmission of one or more test packets.

10. The client device according to claim 9, wherein the test initiation message indicates a timing information for transmission of the sequence of test packets, and wherein the transceiver is configured to cooperate with the processor to:
transmit or receive one or more test packets based on the timing information.

11. The client device according to claim 9, wherein the test initiation message indicates the first transmission direction and further one or more test reception parameters, and wherein the transceiver is configured to cooperate with the processor to:
receive one or more test packets based on the one or more test reception parameters.

12. The client device according to claim 9 , wherein the test initiation message (IM) indicates the second transmission direction and further one or more test transmission parameters, and wherein the transceiver is configured to cooperate with the processor to:
transmit the one or more test packets based on the one or more test transmission parameters.

13. The client device according to claim 9, wherein the first transmission direction is indicated in the test initiation message, and wherein the transceiver is configured to cooperate with the processor to:
receive one or more test packets from the network node, wherein each test packet comprises at least one reference signal;
transmit at least one feedback message to the network node, wherein the feedback message indicates a successful reception of one or more received test packets.

14. The client device according to claim 13, wherein the processor is configured to:
compute an error rate associated with one or more received test packets;
and wherein the feedback message indicates the error rate.

15. The client device according to claim 13, wherein the processor is configured to carry out the method including:
computing a received signal quality associated with one or more received test packets, and
wherein the feedback message indicates the received signal quality.

16. A method for a network node, comprising:
determining a test initiation message, wherein the test initiation message indicates:
a set of client device identities corresponding to a set of client devices participating in a radio configuration test,
a number of test packets in a sequence of test packets, and
at least one transmission direction taken from the group consisting of:
a first transmission direction from the network node to the set of client devices, and
a second transmission direction from the set of client devices to the network node;
transmitting the test initiation message to the set of client devices; and thereafter
transmitting or receiving the sequence of test packets based on the at least one transmission direction indicated in the test initiation message; and
receiving at least one feedback message from each client device in the set of client devices, wherein each feedback message indicates at least one of the group consisting of:
a successful reception of one or more test packets, and
a successful transmission of one or more test packets.

17. The method according to claim 16, wherein the second transmission direction is indicated in the test initiation message, and wherein the method comprises:
receiving the sequence of test packets from the set of client devices, wherein each test packet comprises at least one reference signal; and
receiving at least one feedback message from each client device in the set of client devices, wherein each feedback message indicates a successful transmission of one or more test packets.

18. A method for a client device, comprising:
receiving a test initiation message from a network node, wherein the test initiation message indicates:
a set of client device identities corresponding to a set of client devices participating in a test transmission,
a number of test packets in a sequence of test packets, and
at least one transmission direction taken from the group consisting of:
a first transmission direction from the network node to the set of client devices, and
a second transmission direction from the set of client devices to the network node;
verifying the participation of the client device in the test transmission based on the test initiation message;
transmitting or receiving one or more test packets in the sequence of test packets based on the at least one transmission direction indicated in the test initiation message; and
transmitting at least one feedback message to the network node, wherein the feedback message indicates at least one of the group consisting of:
a successful reception of one or more test packets, and
a successful transmission of one or more test packets.

19. The method according to claim 18, wherein the first transmission direction is indicated in the test initiation message, and wherein the method comprises:
receiving one or more test packets from the network node, wherein each test packet comprises at least one reference signal;
transmitting at least one feedback message to the network node, wherein the feedback message indicates a successful reception of one or more received test packets.

20. A non-transitory machine-readable storage medium having stored thereon processor-executable instructions, which when executed by a processor of a device, cause the device to perform a method comprising:
receiving a test initiation message from a network node, wherein the test initiation message indicates:
a set of client device identities corresponding to a set of client devices participating in a test transmission,
a number of test packets in a sequence of test packets, and
at least one a transmission direction taken from the group consisting of:
a first transmission direction from the network node to the set of client devices, and
a second transmission direction from the set of client devices to the network node;
verifying the participation of the client device in the test transmission based on the test initiation message;
transmitting or receiving one or more test packets in the sequence of test packets based on the at least one transmission direction indicated in the test initiation message;
transmitting at least one feedback message to the network node, wherein the feedback message indicates at least one of the group consisting of:
a successful reception of one or more test packets, and
a successful transmission of one or more test packets.
